(19) United States
(12) Patent Application Publication
(10) Pub. No.: US 2011/0188021 A1
(43) Pub. Date: Aug. 4, 2011

(54) PRINTING APPARATUS

(76) Inventor: Naoki YOSHIDA, Tokyo (JP)

(21) Appl. No.: 12/969,015

(22) Filed: Dec. 15, 2010

(30) Foreign Application Priority Data
Jan. 29, 2010 (JP) 2010-018943

(51) Int. Cl. G03B 27/58

(52) U.S. Cl. 355/72

(57) ABSTRACT

A printing apparatus includes: a photographic printing unit adapted to perform photographic printing on a photographic print surface of a medium including a flexible sheet-like member while maintaining a state where the photographic print surface of the medium faces a photographic printing head; a medium moving unit adapted to generally linearly move the medium in the state where the photographic print surface of the medium faces the photographic printing head of the photographic printing unit; and a photographic printing control unit adapted to control the medium moving unit and the photographic printing unit to perform the photographic printing on the photographic print surface of the medium by the photographic printing head while moving the medium by the medium moving unit.

### BACKGROUND OF THE INVENTION

1. Field of the Invention

The presently disclosed subject matter relates to a printing apparatus, and more particularly, to a printing apparatus adapted to form an image on a photographic print medium such as a lenticular sheet with a certain thickness, stiffness and weight.

2. Description of the Related Art

Regarding a lenticular lens sheet and a cartridge thereof, Japanese Patent Application Laid-Open No. 11-52500 discloses a configuration which prevents errors in transport of the lens sheet. Japanese Patent Application Laid-Open No. 8-137034 discloses an ink jet recording apparatus which corrects a shift in relative positions of an image and a lenticular plate, by using an identification image which is recorded in a margin area of the image. In addition, Japanese Patent Application Laid-Open No. 2007-130769 discloses a tray for transporting a printing medium and a printing apparatus.

### SUMMARY OF THE INVENTION

As in the conventional art, a transport path in a printer which performs printing on a thin photographic print medium such as a copy paper sheet often bends. Such a bending transport path is not suitable for transport of a sheet-like photographic print medium with a certain thickness, stiffness and weight, such as a lenticular sheet. In other words, if such a photographic print medium is transported through the bending transport path, the medium contacts with members included in the printer, and a lens surface or a photographic print surface is scratched.

The presently disclosed subject matter has been made in view of the above described circumstances, and it is an object of the presently disclosed subject matter to provide a printing apparatus which can safely transport a sheet-like photographic print medium.

A first aspect of the presently disclosed subject matter provides a printing apparatus including: a photographic printing unit adapted to perform photographic printing on a photographic print surface of a medium including a flexible sheet-like member while maintaining a state where the photographic print surface of the medium faces a photographic printing head; a medium moving unit adapted to generally linearly move the medium in the state where the photographic print surface of the medium faces the photographic printing head of the photographic printing unit; and a photographic printing control unit adapted to control the medium moving unit and the photographic printing unit to perform the photographic printing on the photographic print surface of the medium by the photographic printing head while moving the medium by the medium moving unit.

A second aspect of the presently disclosed subject matter provides a printing apparatus according to the first aspect, wherein the medium moving unit is adapted to generally vertically move the medium in the state where the photographic print surface of the medium faces the photographic printing head.

A third aspect of the presently disclosed subject matter provides a printing apparatus according to the first aspect, wherein the medium moving unit is adapted to generally horizontally move the medium in the state where the photographic print surface of the medium faces the photographic printing head.

A fourth aspect of the presently disclosed subject matter provides a printing apparatus according to any one of the first to third aspects, wherein the medium moving unit includes: a damper adapted to clamp the medium; a first guide member adapted to generally linearly slide the damper; and a damper drive unit adapted to drive the damper clamping the medium, along the guide member.

A fifth aspect of the presently disclosed subject matter provides a printing apparatus according to the fourth aspect, further including: a medium storage unit adapted to store the medium; and a second guide member adapted to linearly guide the medium from the medium storage unit to the damper.

According to the presently disclosed subject matter, since the sheet-like photographic print medium linearly moves in the photographic printing, the photographic print medium is prevented from contacting with the members of the printing apparatus, and thus, the photographic print surface and the like are prevented from being scratched. Particularly, according to the presently disclosed subject matter, if the photographic print medium is a lenticular sheet, merchandise which is fatally defective in stereoscopic vision with a scratched lens surface is prevented from being made.

### BRIEF DESCRIPTION OF THE DRAWINGS

FIG. 1 is an internal perspective view schematically representing an inside of a printing apparatus according to a first embodiment;

FIG. 2 is a front perspective view of a sheet storage unit;

FIG. 3 is a rear perspective view of the sheet storage unit;

FIG. 4 is a side view of the sheet storage unit;

FIG. 5 is a partially enlarged side view of the sheet storage unit;

FIG. 6 is a perspective view of a sheet feeding cassette in which lenticular sheets are inserted;

FIG. 7 is a perspective view of the sheet feeding cassette whose cassette cover is closed;

FIG. 8 is a schematic side view of the sheet storage unit;

FIG. 9 is a bottom view of the sheet storage unit;

FIG. 10 is an enlarged view of a main portion of the sheet storage unit;

FIG. 11 is an enlarged view of the main portion of the sheet storage unit;

FIG. 12 is an enlarged view of the main portion of the sheet storage unit;

FIG. 13 is a perspective view illustrating a schematic configuration of a damper and a damper transport unit;

FIG. 14 is a plan view illustrating the schematic configuration of the damper and the damper transport unit;

FIG. 15 is a schematic view of a ribbon switching gatling mechanism;

FIG. 16 is a schematic view of a sheet transport path;

FIG. 17 is a schematic view of a sheet transport path;

FIG. 18 is a block diagram illustrating a configuration of a main portion of the printing apparatus;

FIG. 19A is a flowchart of a photographic printing process;

FIG. 19B is a flowchart of a photographic printing process;

FIG. 20 is an internal perspective view schematically representing the inside of the printing apparatus when a photographic print medium is fed;

FIG. 21 is an internal perspective view schematically representing the inside of the printing apparatus when the photographic print medium is returned;

FIG. 22 is an internal perspective view schematically representing the inside of the printing apparatus when photographic printing is resumed;

FIG. 23 is a perspective view of a different form of the sheet feeding cassette in which the lenticular sheets are inserted;

FIG. 24 is an internal perspective view schematically representing another example of the inside of the printing apparatus when the photographic print medium is returned; and

FIG. 25 is an internal perspective view schematically representing an inside of a horizontally placed printing apparatus according to a second embodiment.

### DETAILED DESCRIPTION OF THE PREFERRED EMBODIMENTS

Hereinafter, embodiments of a printing apparatus according to the presently disclosed subject matter will be described according to the accompanying drawings.

### [Overall Configuration of Printing Apparatus]

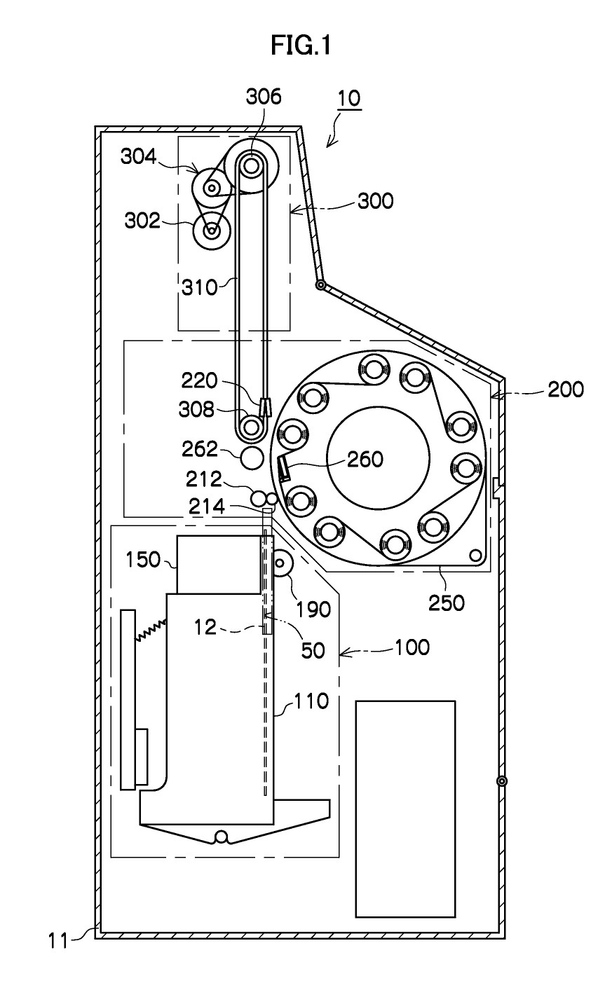

FIG. 1 is an internal perspective view schematically representing a printing apparatus 10 according to a first embodiment of the presently disclosed subject matter, and illustrating the printing apparatus 10 in a state where a photographic print medium is fed from a sheet feeding cassette.

This printing apparatus 10 is a vertically placed printer which transports a transparent resin photographic print medium (hereinafter referred to as “lenticular sheet”) 12 and performs photographic printing for the lenticular sheet 12, in a vertical direction. The lenticular sheet 12 includes a lens surface with a so-called lenticular lens having a half-cylinder shaped lens group, formed on a surface of the lenticular sheet 12, and a photographic print surface which is on the reverse side of the lens surface. This printing apparatus 10 includes a sheet storage unit 100, a photographic printing unit 200, and a free feeding unit 300. A material of the lenticular sheet 12 includes a heat-resistant, flexible member which is adapted to a photographic printing operation of a thermal head 260. This member is transparent resin, for example, PET (polyethylene terephthalate resin), PMMA (Poly(methyl methacrylate), acrylic resin) or PC (polycarbonate resin). Moreover, the lenticular sheet 12 may have any thickness, for example, 0.3 mm (millimeter).

Moreover, this printing apparatus 10 is a sublimation printer using ink ribbons of R (image receiving layer), Y (yellow), M (magenta), C (cyan) and W (white), in which moving up (in the photographic printing) and moving down (feeding backward to a photographic printing start position) are repeatedly performed for each photographic print color, and a transport path 50 for the lenticular sheet 12 includes the same straight path for both moving up and down.

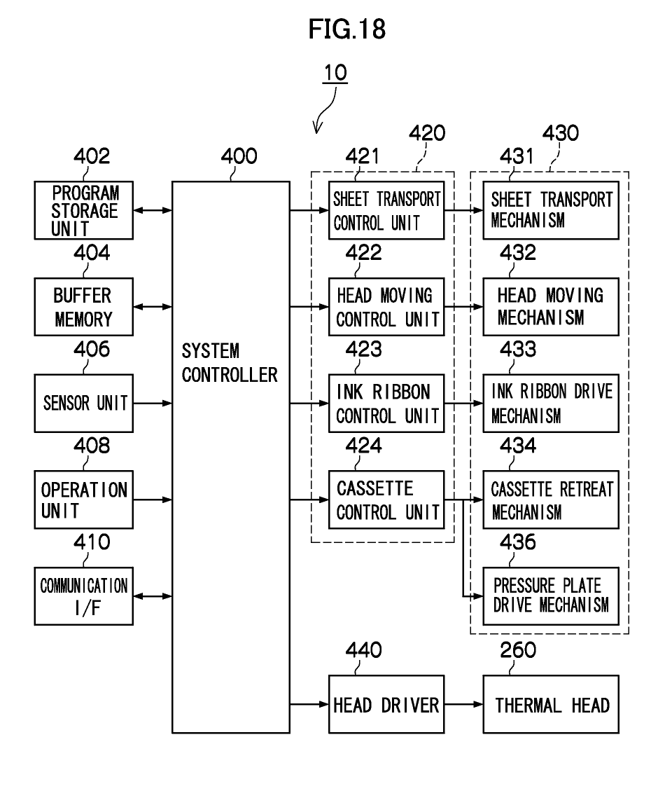

In this printing apparatus 10, a system controller 400 (see FIG. 18) is disposed, and operations of the respective units in the printing apparatus 10 are controlled by a control device. A control system will be described in detail later.

### <Sheet Storage Unit>

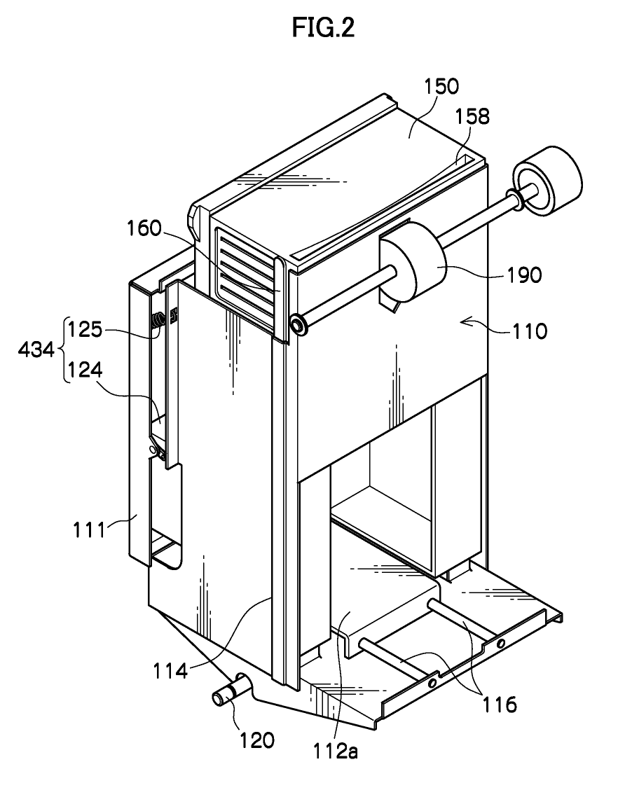

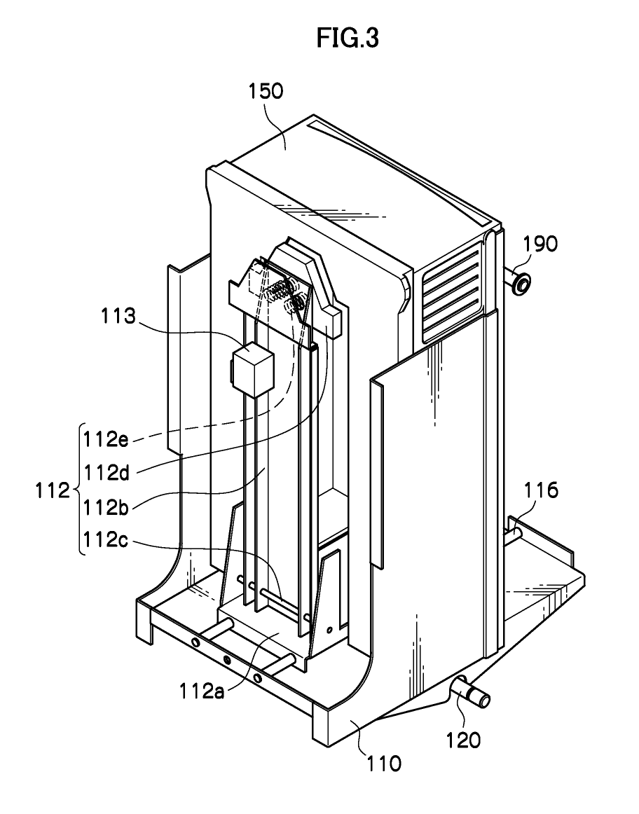

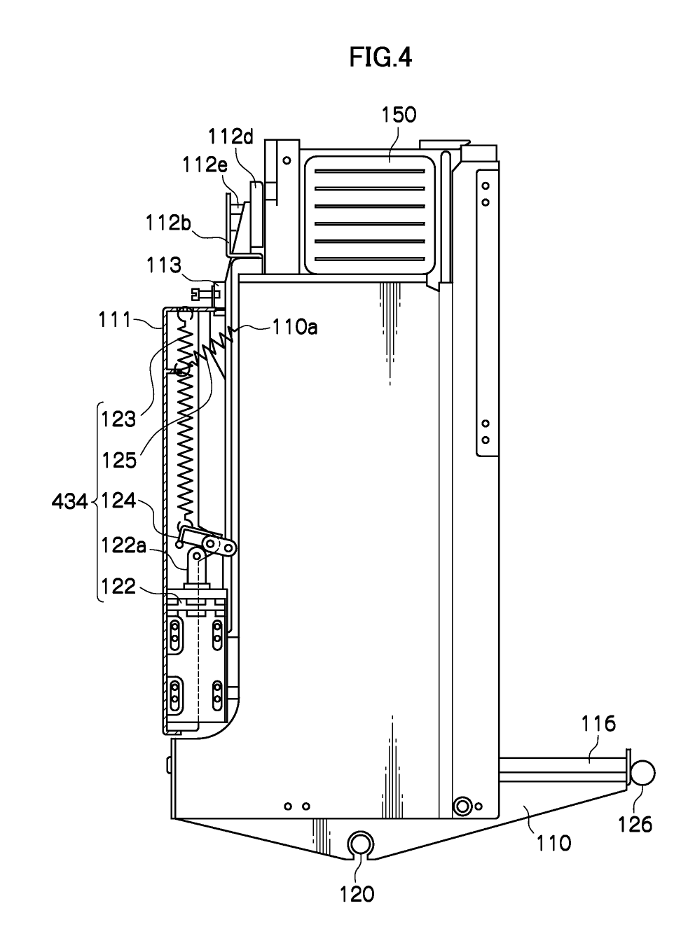

FIGS. 2 and 3 are perspective views illustrating a detailed configuration of the above described sheet storage unit 100. FIG. 4 is a side view illustrating the detailed configuration of the sheet storage unit 100.

This sheet storage unit 100 includes a sheet storage main body 110, a fixed plate 111, a pressure plate 112 and a sheet feeding cassette 150. The sheet feeding cassette 150 can be mounted so as to be attachable and detachable to and from the sheet storage main body 110. The fixed plate 111 is fixed to a frame 11 of the printing apparatus 10, and the sheet storage main body 110 is disposed turnably with respect to the fixed plate 111.

As illustrated in FIGS. 2 to 4, the sheet storage main body 110 is disposed in a manner rockable around a rotation shaft 120 of a bottom portion, and is adapted to be able to be rocked by a cassette retreat mechanism 434 (see FIG. 18). As illustrated in FIG. 4, the cassette retreat mechanism 434 includes a solenoid 122, a spring 123, a link mechanism 124, an urging spring 125 and a stopper 126.

The solenoid 122 is, for example, a pull-type solenoid, and is adapted so that a piston 122a is moved up and down (moved in upper/lower directions in FIG. 4). The urging spring 125 is, for example, a coil spring whose both ends are disposed on the fixed plate 111 and a side 111a of the sheet storage main body 110 so that the sheet storage main body 110 is urged by force in a direction of counterclockwise rotation around the rotation shaft 120.

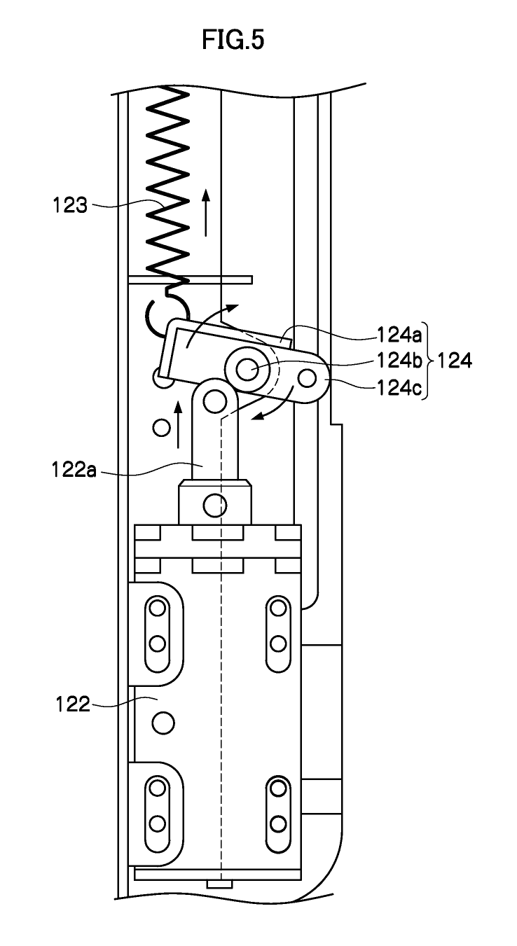

As illustrated in FIG. 5, the link mechanism 124 includes a lever 124a, a turning shaft 124b and an arm 124c. The lever 124a and the arm 124c are disposed in a manner turnable around the turning shaft 124b. The spring 123 and the piston 122a are coupled to the lever 124a. The lever 124a is turned clockwise around the turning shaft 124b by urging force of the spring 123, and the lever 124a is turned counterclockwise around the turning shaft 124b by urging force of the piston 122a.

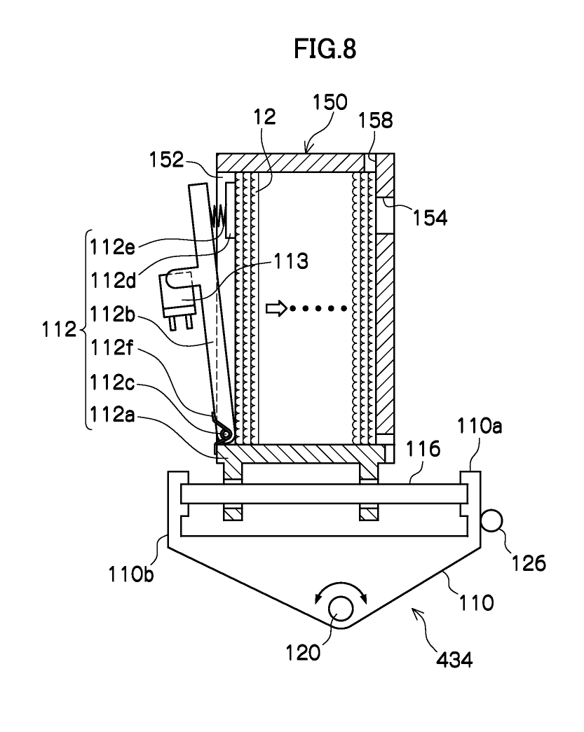

Usually, energization to the solenoid 122 is turned on, and the piston 122a is drawn in the lower direction. If the piston 122a is drawn in the lower direction, the arm 124c pushes the sheet storage main body 110 through the pressure plate 112. Thereby, the sheet storage main body 110 is urged by force in a direction of clockwise rotation around the rotation shaft 120. The stopper 126 (see FIG. 8) is disposed at a position where the stopper 126 contacts with the sheet storage main body 110 when the sheet storage main body 110 is retained at a vertical position. Clockwise turning of the sheet storage main body 110 is stopped when the sheet storage main body 110 contacts with the stopper 126.

When the energization to the solenoid 122 is turned off, as illustrated in FIG. 5, the lever 124a is turned clockwise around the turning shaft 124b by the spring 123, and the piston 122a is pulled up in the upper direction. When the piston 122a is pulled up in the upper direction, the arm 124c is turned clockwise. Thereby, force of the arm 124c pressing the side of the sheet storage main body 110 is eliminated, and the sheet storage main body 110 is turned counterclockwise around the rotation shaft 120 by urging force of the urging spring 125. A stopper (not illustrated) is disposed at a position where the stopper contacts with the sheet storage main body 110 when the sheet storage main body 110 tilts by a predetermined angle (for example, 30°). The counterclockwise turning of the sheet storage main body 110 is stopped when the sheet storage main body 110 contacts with this stopper.

It should be noted that a specific configuration of the cassette retreat mechanism 434 is not limited to the illustrated configuration. Any mechanism may be used in which the sheet storage main body 110 can be turned clockwise or counterclockwise around the rotation shaft 120. Moreover, as the solenoid 122, a push-type solenoid or a push/pull-type solenoid may be used instead of the pull-type solenoid. Moreover, the sheet storage main body 110 may be urged by force in a direction of the clockwise turning around the rotation shaft 120, by the urging spring, and the sheet storage main body 110 may be turned counterclockwise around the rotation shaft 120 by the link mechanism 124.

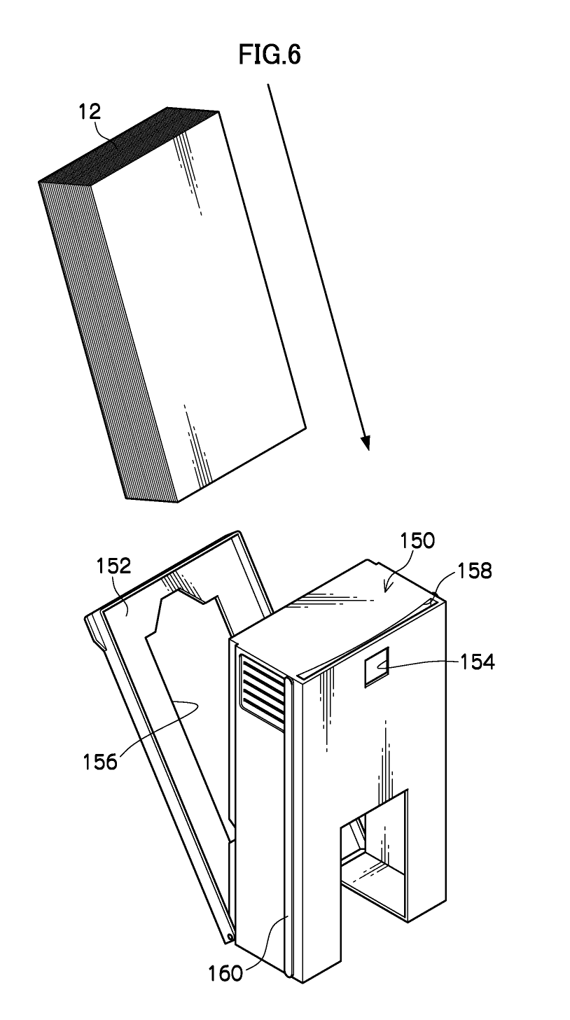

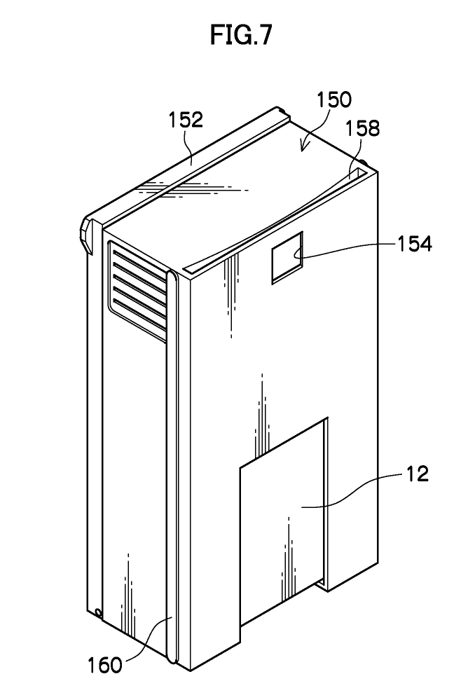

FIGS. 6 and 7 are perspective views of the sheet feeding cassette 150, respectively. FIG. 6 illustrates a situation where a cassette cover 152 of the sheet feeding cassette 150 is opened, and about 100 to 200 stacked lenticular sheets 12 are inserted into the sheet feeding cassette 150. FIG. 7 illustrates a state where the cassette cover 152 is closed after the lenticular sheets 12 are inserted into the sheet feeding cassette 150.

On the front of this sheet feeding cassette 150, an opening 154 is formed in which a feed roller 190 (see FIG. 2) is inserted. On the other hand, on the cassette cover 152 on the rear of this sheet feeding cassette 150, a pressure plate opening 156 is formed in which the L-shaped pressure plate 112 (see FIG. 3) is inserted.

Moreover, on the top of the sheet feeding cassette 150, there is formed an outlet 158 through which one of the lenticular sheets 12 is outputted from the cassette. The outlet 158 is formed to have a width which is narrowest at a central portion and becomes wider toward both ends. A generally central portion of the outlet 158 is formed to have a width W which is wider than a sheet thickness t of one lenticular sheet 12, and narrower than a sheet thickness 2t of two lenticular sheets 12. The outlet 158 is formed to have the width which is narrowest at the central portion and becomes wider toward the both ends, in consideration that a generally central portion of the lenticular sheet 12 is pressed by the pressure plate 112 (to be described in detail later) and thus the both ends bend accordingly.

On the side of the sheet feeding cassette 150, a ridge 160 is formed in the vertical direction. The ridge 160 of the sheet feeding cassette 150 engages with a groove 114 formed on the side of the sheet storage main body 110, and thereby, the sheet feeding cassette 150 is positioned at a predetermined position in the sheet storage main body 110.

As illustrated in FIG. 8, when the sheet feeding cassette 150 is inserted into the sheet storage main body 110, the lenticular sheets 12 stored in the sheet feeding cassette 150 are placed on the generally L-shaped pressure plate 112 on the sheet storage main body 110.

As illustrated in FIGS. 3 and 8, the pressure plate 112 includes a bottom portion 112a, a rear portion 112b, a rocking shaft 112c, a pushing plate 112d, an elastic member 112e and an elastic member 112f, and is supported with one degree of freedom in directions of the front and the rear (in left and right directions on FIG. 8) by two guide shafts 116.

Two ribs are formed on the bottom portion 112a. Holes in which the two guide shafts 116 are inserted are formed in the two ribs. The bottom portion 112a is slid along the two guide shafts 116, and thereby, the lenticular sheets 12 are slid. The rocking shaft 112c is disposed on the bottom portion 112a.

The rear portion 112b is rockably disposed on the bottom portion 112a through the rocking shaft 112c. Rocking of the rear portion 112b is detected by a rocking sensor 113 disposed on the fixed plate 111 (FIG. 4). The rocking sensor 113 outputs a Lo signal when the rocking of the rear portion 112b is not detected, and outputs a Hi signal when the rocking of the rear portion 112b is detected.

On the front side near the upper end of the rear portion 112b, the pushing plate 112d is disposed through the elastic member 112e. Moreover, the elastic member 112f (see FIG. 8) is disposed on the rear side of the rear portion 112b. When the pushing plate 112d is caused to contact with the lenticular sheets 12, the lenticular sheets 12 are urged by urging force in the front direction (the right direction on FIG. 8) by the elastic member 112e and the elastic member 112f.

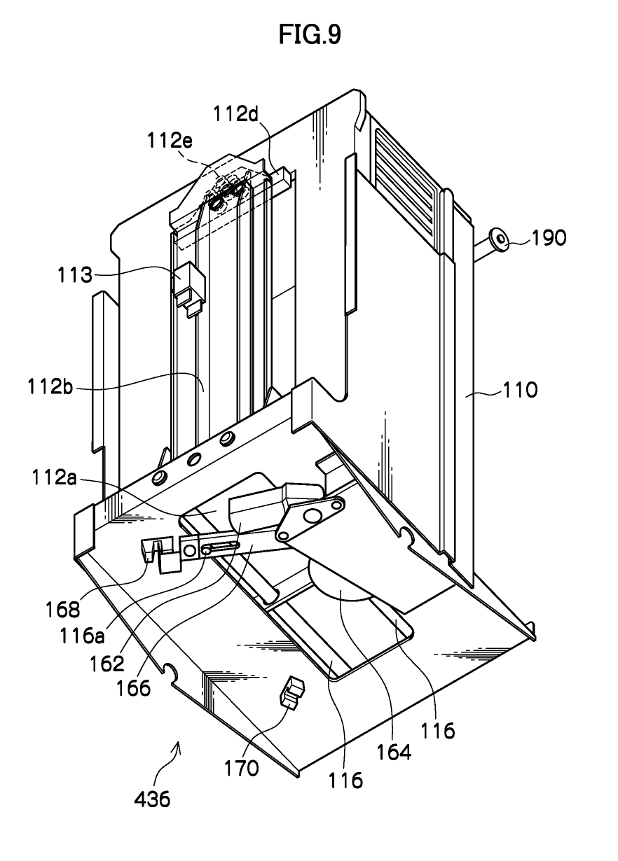

As illustrated in FIG. 9, the pressure plate 112 can be slid in the front direction or the rear direction (moved parallel) by a pressure plate drive mechanism 436, in a state where the lenticular sheets 12 are placed on the pressure plate 112. The pressure plate drive mechanism 436 is disposed on the bottom of the sheet storage main body 110, and includes a motor 162, a gearbox 164, an arm 166, and detection switches 168 and 170.

The gearbox 164 includes, for example, a mechanism which transmits motion between non-parallel axes of a worm formed integrally with an output shaft of the motor 162, and a worm wheel meshing with the worm, or the like, and transmits an output of the motor 162 to the arm 166. The motor 162 is forward/reverse rotatable. For example, with forward rotation of the motor 162, the arm 166 causes the sheet storage main body 110 to turn counterclockwise as viewed from the bottom. With reverse rotation of the motor 162, the arm 166 causes the sheet storage main body 110 to turn clockwise as viewed from the bottom.

Each of the detection switches 168 and 170 is, for example, a transmissive photointerrupter in which a light emitting element and a light receiving element face each other at a certain interval, and which detects passing of an object between the light emitting element and the light receiving element. When a leading end of the arm 166 passes through a detection gap between the light emitting element and the light receiving element of each of the detection switches 168 and 170, each of the detection switches 168 and 170 is turned on, and the rotation of the motor 162 is stopped.

An elongate hole is formed in the arm 166, and a pin 116a formed downward on the bottom of the pressure plate 112 is inserted into the elongate hole. The pin 116a slides in the elongate hole along with the turning of the arm 166, and thereby, the pressure plate 112 is moved parallel. In the present embodiment, when the arm 166 causes the sheet storage main body 110 to turn counterclockwise as viewed from the bottom, the pressure plate 112 is moved in the front direction. When the arm 166 causes the sheet storage main body 110 to turn clockwise as viewed from the bottom, the pressure plate 112 is moved in the rear direction.

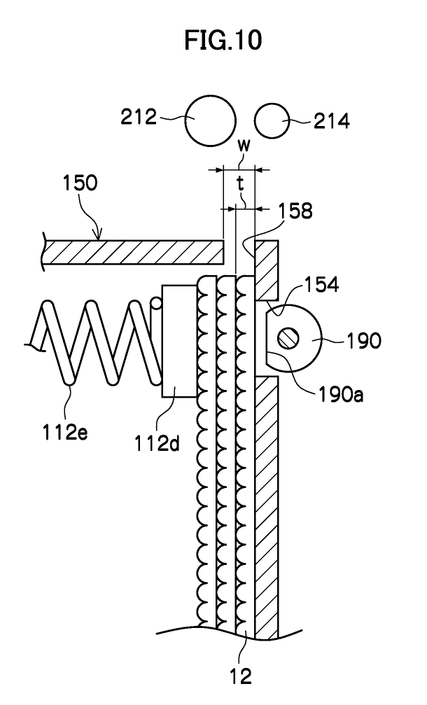

A detection device (not illustrated) is disposed in the sheet storage main body 110. As illustrated in FIG. 10, when the sheet feeding cassette 150 is inserted into the sheet storage main body 110, the pressure plate 112 is moved in the front direction by the pressure plate drive mechanism 436, and the pushing plate 112d presses the lenticular sheets 12 in the sheet feeding cassette 150. When a pressure sensor (not illustrated) detects that the lenticular sheets 12 are pressed with a certain pressure, the moving of the pressure plate 112 in the front direction is stopped.

The feed roller 190 (see FIG. 1) outputs the lenticular sheet 12 pressed with the certain pressure by the pressure plate 112, from the sheet feeding cassette 150. When the lenticular sheet 12 is outputted from the sheet feeding cassette 150, force of the pushing plate 112d pressing the lenticular sheets 12 is reduced, and the rear portion 112b rocks. When the rocking of the rear portion 112b is detected and the Hi signal is outputted by the rocking sensor 113 (see FIG. 9), the pressure plate 112 is moved in the front direction by the pressure plate drive mechanism 436 until it is detected that the lenticular sheets 12 are pressed with a predetermined pressure. Thereby, a position of the pressure plate 112 is controlled so that the pressure plate 112 constantly presses the lenticular sheets 12 with the certain pressure.

As illustrated in FIG. 10, the feed roller 190 is a cross-sectionally D-shaped (D-cut) and rod-shaped member. The feed roller 190 is formed with a material, for example, rubber or the like, so that a friction coefficient μ2 between the feed roller 190 and the lenticular sheet 12 is larger than a friction coefficient μ1 between the lenticular sheets 12.

If the detection device (not illustrated) detects that the sheet feeding cassette 150 is not inserted into the sheet storage main body 110, a position of the feed roller 190 in a rotation direction is controlled so that a straight portion 190a faces the pushing plate 112d. In this case, since the feed roller 190 and the lenticular sheet 12 do not contact with each other, the insertion of the sheet feeding cassette 150 into the sheet storage main body 110 is not prevented. As illustrated in FIG. 10, when the sheet feeding cassette 150 is inserted into the sheet storage main body 110, the lenticular sheets 12 are pressed by the pushing plate 112d so as to be set in a waiting state where the feed roller 190 can rotate.

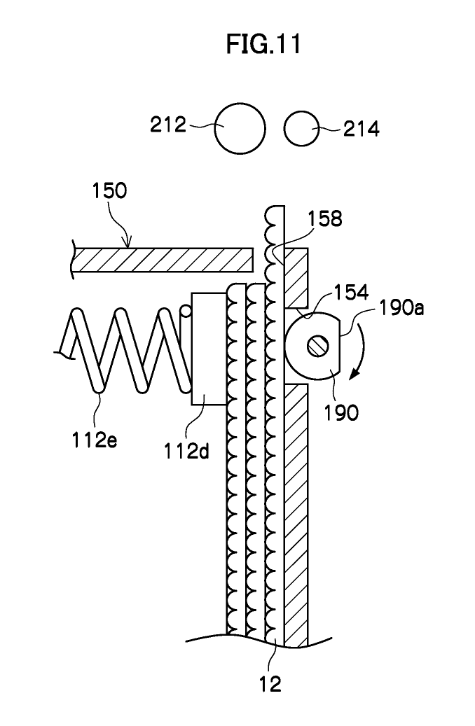

As illustrated in FIG. 11, when the feed roller 190 is driven to rotate in a feed direction in a state where the lenticular sheets 12 are pressed, the lenticular sheet 12 contacting with the feed roller 190 is moved in response to the rotation of the feed roller 190, and the lenticular sheet 12 is fed through the outlet 158 of the sheet feeding cassette 150. The outlet 158 is formed to have the width W which is wider than the sheet thickness t and narrower than the sheet thickness 2t of two sheets. Thereby, only one lenticular sheet 12 is fed through the outlet 158.

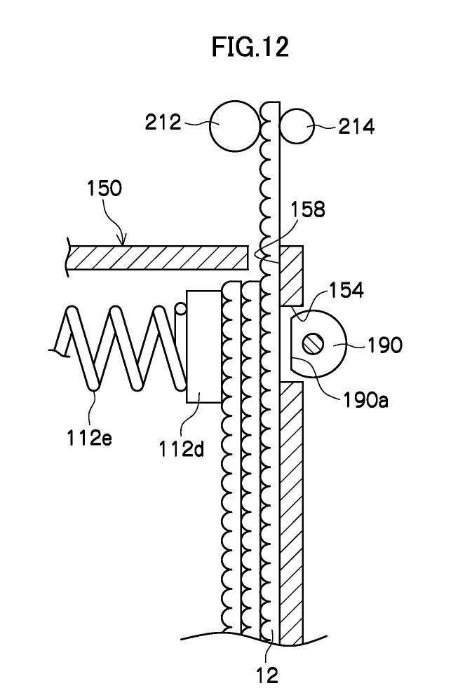

As illustrated in FIG. 12, when the feed roller 190 further rotates and reaches a position where the straight portion 190a faces the lenticular sheet 12, the rotation is controlled to be stopped. Thereby, the lenticular sheet 12 is fed from the sheet feeding cassette 150 by a certain amount (for example, to a position where a downstream-side end portion of the lenticular sheet 12 can be clamped between a transport roller 212 and a capstan 214). Moreover, at this time, the feed roller 190 does not contact with the lenticular sheet 12 (frictional force from the feed roller 190 does not act on the lenticular sheet 12).

### <Photographic Printing Unit>

As illustrated in FIG. 1, the photographic printing unit 200 includes a sheet transport mechanism 431 (see FIG. 18) which transports the lenticular sheet 12 in the photographic printing or the like, a ribbon switching gatling mechanism 250 in which the R, Y, M, C and W ink ribbons are loaded, and the thermal head 260.

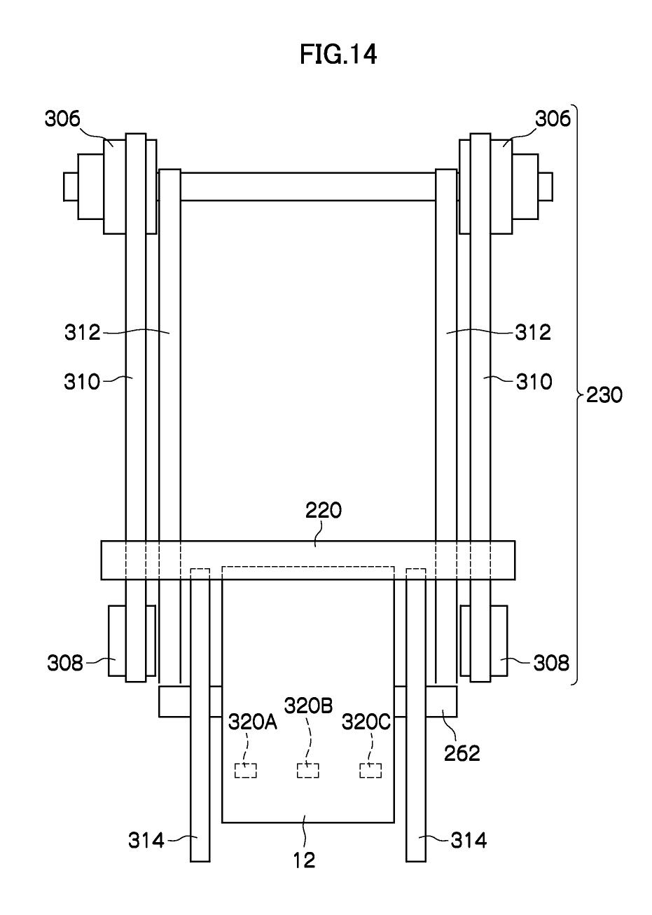

The sheet transport mechanism 431 includes the feed roller 190, the transport roller 212, the capstan 214, a damper 220 (see FIG. 1 for the above members), and a clamper transport unit 230 (see FIG. 14) which moves the damper 220.

As illustrated in FIG. 12, a leading end portion of the lenticular sheet 12 fed from the sheet feeding cassette 150 by the certain amount by the feed roller 190 reaches a position of the transport roller 212. Here, the capstan 214 is pressure-bonded to the transport roller 212 through the lenticular sheet 12, and also, the transport roller 212 is driven. Thereby, the lenticular sheet 12 can be transported. It should be noted that, instead of providing the feed roller 190, the leading end portion of each lenticular sheet 12 may reach the position of the transport roller 212 one by one by manually feeding each lenticular sheet 12.

This transport of the lenticular sheet 12 by the transport roller 212 and the capstan 214 is performed until the leading end of the lenticular sheet 12 reaches the clamper 220 waiting at a predetermined lowest position. It should be noted that, in the clamper 220, a pair of clamp members are constantly urged in a closing direction by a spring, while in the above described waiting state, the pair of clamp members are waiting in a state where the pair of clamp members are opened against urging force of the spring, by a cam and the like (see FIG. 1).

When the leading end of the lenticular sheet 12 reaches the above described damper 220, the leading end of the lenticular sheet 12 is clamped by the damper 220, and the capstan 214 (see FIG. 1) is caused to retreat from the transport roller 212. Subsequently, the lenticular sheet 12 is transported (moved up and down) along with the damper 220 by the damper transport unit 230.

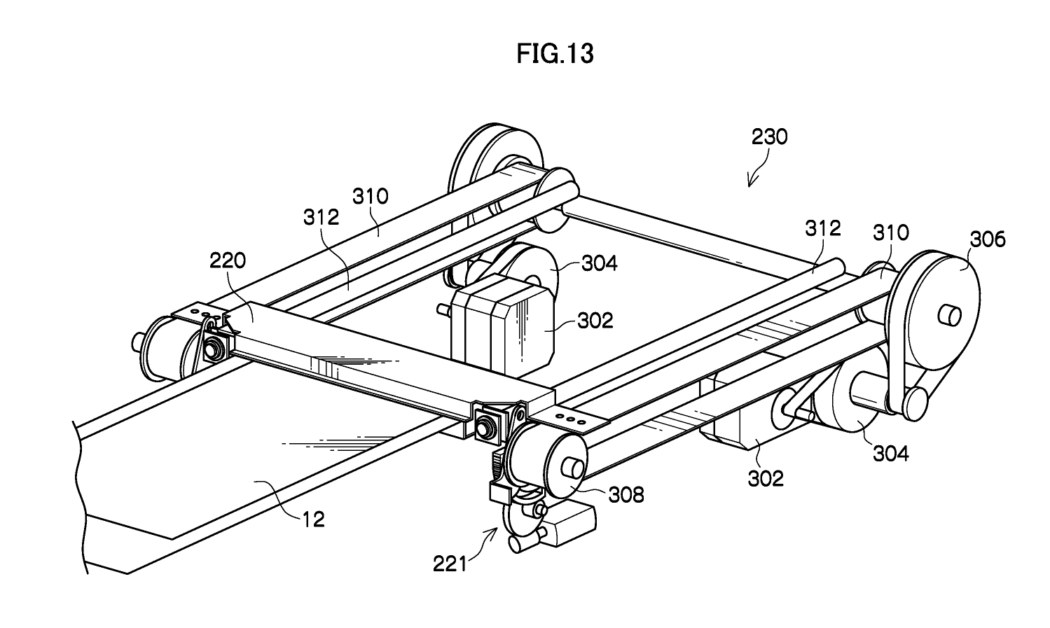

FIG. 13 is a perspective view illustrating a schematic configuration of the damper 220 and the damper transport unit 230 as described above. FIG. 14 is a plan view illustrating the schematic configuration of the damper 220 and the damper transport unit 230 as described above.

A pair of drive pulleys 306, each of which is driven by a drive motor 302 through a deceleration mechanism 304, is provided at an upper end portion of the free feeding unit 300 illustrated in FIG. 1. A pair of driven pulleys 308 is provided near a platen roller 262.

Drive belts 310 are wound between the drive pulleys 306 and the driven pulley 308, and the clamper 220 is fixed between the drive belts 310 by bolts (not illustrated), as illustrated in FIGS. 13 and 14.

Moreover, guide rails 312 which guide the damper 220 in the vertical direction along the drive belts 310 are disposed. Furthermore, resin guides 314 which guide the lenticular sheet 12 fed by the transport roller 212 and the capstan 214, to the clamper 220 waiting at the predetermined lowest position are disposed. It should be noted that rubber guides may be disposed instead of the resin guides 314.

A width of a pair of the resin guides 314 is wider than a width of the lenticular sheet 12 by a predetermined clearance, and the resin guides 314 guide the lenticular sheet 12 along the vertical direction.

Moreover, three photosensors 320A, 320B and 320C are disposed parallel to the platen roller 262, on an entrance side of the platen roller 262. Light-emitting diodes (LEDs) (not illustrated) are disposed at positions facing the photosensors 320A, 320B and 320C across a delivery path of the lenticular sheet 12.

A detection signal for the lenticular sheet 12 detected by the photosensors 320A, 320B and 320C has a maximum value if an optical axis of the photosensor coincides with the center of a lens of the lenticular sheet 12, and becomes minimum if the optical axis is located at a lowest position between the lenses. Therefore, a tilt with respect to a transport direction (azimuth angle) of the lenticular sheet 12 can be sensed based on the detection signals from the three photosensors 320A, 320B and 320C.

Azimuth adjustment (adjustment for setting the azimuth angle to 0) for the lenticular sheet 12 is performed by clamping the leading end of the lenticular sheet 12 by the clamper 220, then driving the pair of left and right drive pulleys 306 independently from each other while monitoring the detection signals from the three photosensors 320A, 320B and 320C, and slightly tilting the damper 220 by an amount of the azimuth adjustment.

After the azimuth adjustment is performed as described above, the damper 220 is moved up so as to transport the lenticular sheet 12 to the photographic printing start position, and subsequently, the photographic printing by the thermal head 260 is started. When the photographic printing of one color is completed, a return operation is performed in which the drive pulleys 306 are reversed to move down the damper 220 and the lenticular sheet 12 is returned to the photographic printing start position again.

The damper 220 clamping the lenticular sheet 12 linearly moves up and down in the vertical direction along the guide rails 312. Moreover, in the photographic printing, since the lenticular sheet 12 moves up or down along the vertical direction, the lenticular sheet 12 is hardly bent under the sheet's own weight (significant bending occurs particularly on a photographic print medium with a low stiffness such as the lenticular sheet 12 of a thin type). Consequently, in the photographic printing, the lenticular sheet 12 is prevented from contacting with members of the printing apparatus 10, and thus, the lens surface and the photographic print surface of the lenticular sheet 12 are prevented from being scratched. Accordingly, merchandise which is fatally defective in stereoscopic vision is prevented from being made.

### <Ribbon Switching Gaffing Mechanism and Thermal Head>

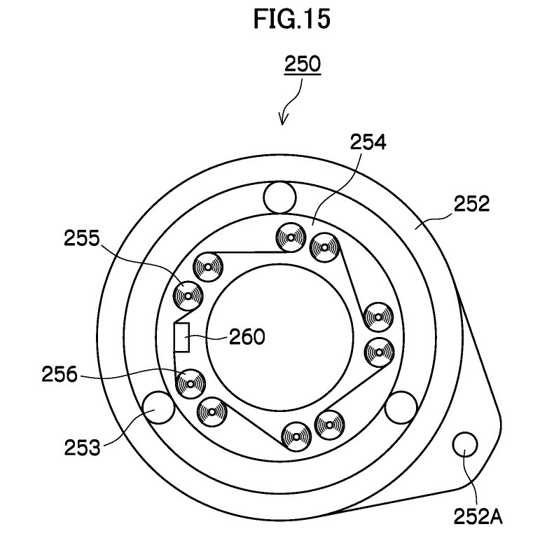

FIG. 15 is a schematic view of the ribbon switching gatling mechanism 250.

As illustrated in FIG. 15, the ribbon switching gatling mechanism 250 has a ribbon cage holder 252 and a ribbon cage 254 so that the ribbon cage holder 252 can rock around a ribbon cage holder rocking shaft 252A.

The thermal head 260 is provided within the ribbon cage holder 252, and is disposed at a leading end of an arm member (not illustrated) which is turnably provided on a shaft on the same axis as the ribbon cage holder rocking shaft 252A. The thermal head 260 can be moved between a photographic printing position and a retreat position by turning this arm member.

The ribbon cage holder 252 can be moved between the photographic printing position and a maintenance position by rocking (turning) the ribbon cage holder 252 around the ribbon cage holder rocking shaft 252A. A part of the ribbon cage holder 252 can be protruded from an apparatus main body at the maintenance position.

The thermal head 260 moves in an interlocked manner with the moving of the ribbon cage holder 252 to the maintenance position, and moves to a position where a heating element of the thermal head 260 can be touched from outside. Thereby, maintenance such as cleaning and replacement of the thermal head 260 can be easily performed.

On the other hand, the ribbon cage 254 is rotatably supported in the ribbon cage holder 252 by ribbon cage rotation receivers 253. Five pairs of take-up reels 255 and supply reels 256 are disposed at regular intervals in the ribbon cage 254, and the R, Y, M, C and W ink ribbons are set to the five pairs of reels, respectively. The ribbon cage 254 is rotated by the gatling mechanism so that a desired ribbon comes to a position of the thermal head 260.

The take-up reel 255 in one pair of the take-up reel 255 and the supply reel 256 which is moved to the position of the thermal head 260 takes up the ink ribbon through a friction clutch at a speed which is slightly faster than a moving speed of the lenticular sheet 12, in the photographic printing. The supply reel 256 is braked so that predetermined back tension acts on the ink ribbon. Thereby, in the photographic printing, when the lenticular sheet 12 moves, the ink ribbon is fed in an interlocked manner (in synchronization) with this moving of the lenticular sheet 12.

In the photographic printing, the thermal head 260 is moved by a head moving mechanism to the photographic printing position where the thermal head 260 contacts with the platen roller 262 through the ink ribbon and the lenticular sheet 12. Also, when the ink ribbon is switched or the lenticular sheet 12 is fed backward, the thermal head 260 is moved to the retreat position where the thermal head 260 retreats from the platen roller 262.

Moreover, the thermal head 260 is driven depending on multi-view images (six-view images in this embodiment) for a 3D image as will be described later, and sublimates ink on the ink ribbon to transfer the ink to the lenticular sheet 12.

### <Sheet Transport Path>

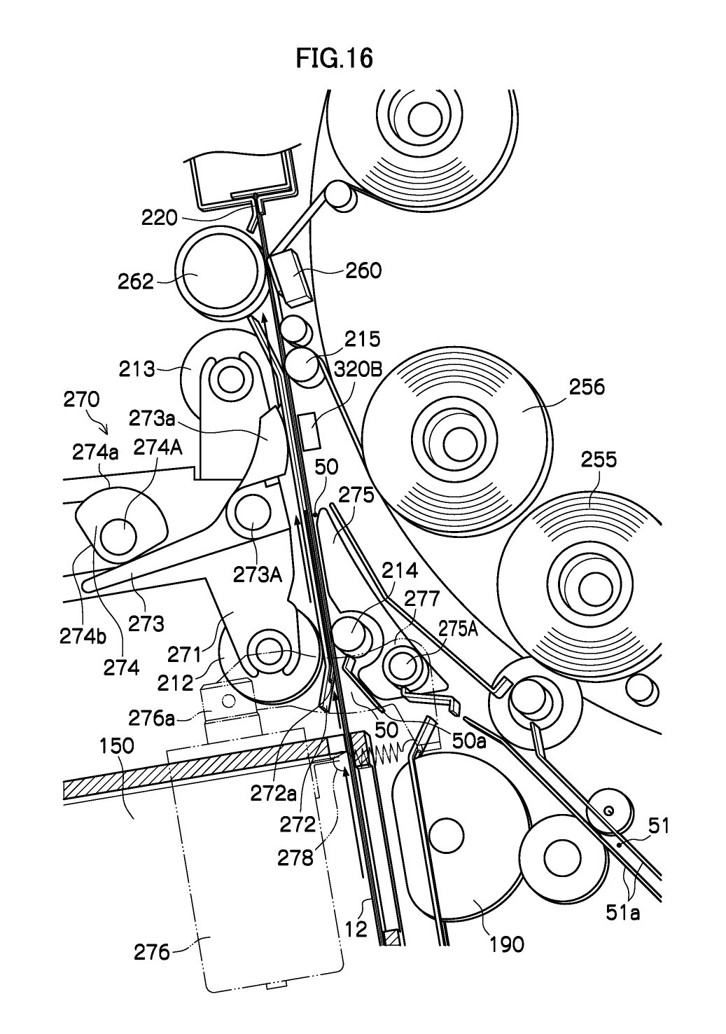

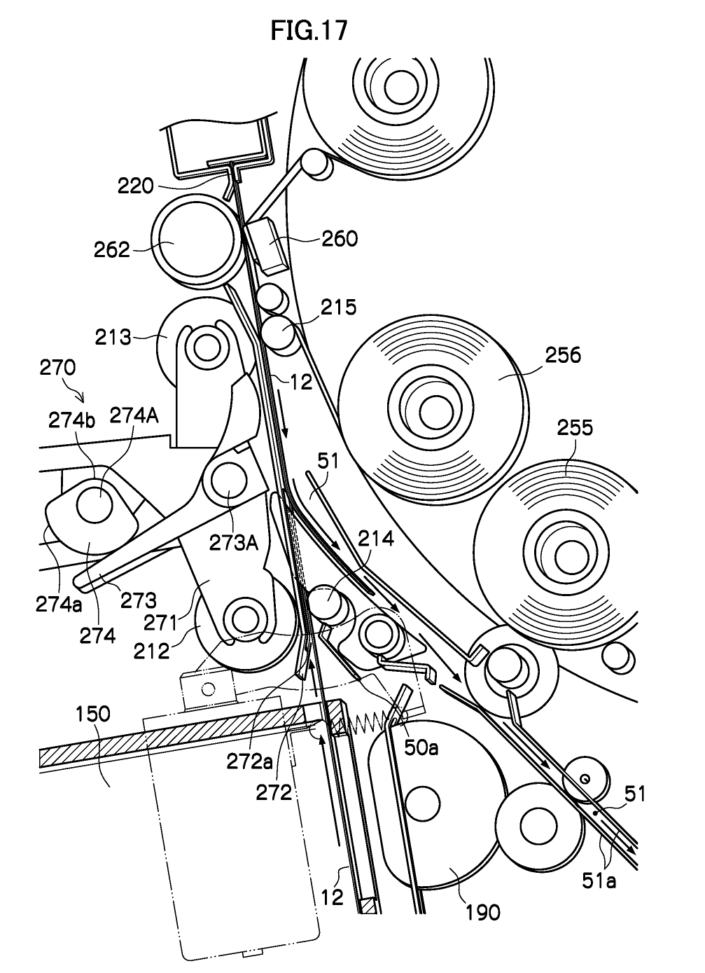

FIGS. 16 and 17 are schematic views of sheet transport paths. FIG. 16 illustrates a state where the lenticular sheet 12 is transported through a transport path A 50, and FIG. 17 illustrates a state where the lenticular sheet 12 is transported through a transport path B 51. The sheet transport path includes the transport path A 50 through which the lenticular sheet 12 moves up and down in the printing, and the transport path B 51 through which the lenticular sheet 12 is transported to the outlet after the printing.

The transport path A 50 and the transport path B 51 include a mounting plate 271, a protective member 272, a lever 273, a cam 274 and a transport path switching member 275.

The protective member 272 is a plate-like member whose both ends are warped, and is fixed to the frame 11. An elongate hole 272a which enables the transport rollers 212 and 213 to contact with the lenticular sheet 12 is formed in the protective member 272. Since the protective member 272 is formed with a soft material such as rubber or resin, the photographic print surface and the lens surface of the lenticular sheet 12 are prevented from being scratched when the lenticular sheet 12 is transported.

The transport rollers 212 and 213 are rotatably disposed at a leading end of the mounting plate 271 so that the transport rollers 212 and 213 are generally aligned with the platen roller 262, and leading ends of the transport rollers 212 and 213 protrude through the elongate hole 272a to be in pressure contact with the capstans 214 and 215. Thus, when the transport roller 212 rotates, the lenticular sheet 12 is transported from the sheet feeding cassette 150 to the damper 220 through the transport path A 50.

On the mounting plate 271, the lever 273 is disposed in a manner turnable around a turning shaft 273A, and the cam 274 is disposed in a manner rotatable around a rotation shaft 274A. The cam 274 is formed in a generally sector shape having two arcs 274a and 274b with different radiuses. The lever 273 is urged by an elastic member (not illustrated) in a direction for contacting with the cam 274 (clockwise in FIG. 16). Thereby, the lever 273 is turned in response to rotation of the cam 274.

If the arc 274b of the cam 274 contacts with the lever 273, as illustrated in FIG. 16, a leading end of a pressing portion 273a at a leading end of the lever 273 protrudes through the elongate hole 272a to push the lenticular sheet 12, which is transported through the transport path A 50, toward the photosensors 320A to 320C (only the photosensor 320B is illustrated in FIG. 16). Thereby, the detection by the photosensors 320A to 320C can be stabilized, and precision of the azimuth adjustment can be increased.

When position adjustment such as the azimuth adjustment is completed, the cam 274 rotates, and the arc 274a of the cam 274 is caused to contact with the lever 273. Thereby, as illustrated in FIG. 17, the lever 273 is caused to retreat so that the pressing portion 273a does not contact with the lenticular sheet 12.

The transport path switching member 275 is disposed to the frame 11 in a manner turnable around a rotation shaft 275A. A lever 277 is fixed to the transport path switching member 275 in a manner turnable around the rotation shaft 275A.

A piston 276a of a solenoid 276 is disposed on one end of the lever 277, and an urging spring 278 is disposed on the other end. The solenoid 276 is, for example, a pull-type solenoid, and is adapted so that the piston 276a is moved up and down. The urging spring 278 is, for example, a coil spring, whose one end is disposed on the lever 277 and the other end is disposed on the side of the solenoid 276.

The piston 276a is usually positioned at an upper end, as illustrated in FIG. 16. The transport path switching member 275 and the lever 277 are urged clockwise in FIG. 16, around the rotation shaft 275A by urging force of the urging spring 278. Thus, the transport path switching member 275 is arranged at a first position where the transport path switching member 275 does not intersect with the protective member 272, and the transport path A 50 is formed by the protective member 272, the transport path switching member 275, and a rib 50a.

When the solenoid 276 is turned on, the piston 276a is moved in a lower direction against the urging force of the urging spring 278. As a result, as illustrated in FIG. 17, the lever 277 turns counterclockwise in FIG. 17, around the rotation shaft 275A. Along with the turning of the lever 277, the transport path switching member 275 also turns counterclockwise around the rotation shaft 275A, and the transport path switching member 275 is arranged at a second position where the transport path switching member 275 intersects with the protective member 272. Thereby, the transport path B 51 is formed by the protective member 272, the transport path switching member 275, and ribs 51a.

The lenticular sheet 12 moved in the lower direction by the damper 220 contacts with the transport path switching member 275, and bends along the transport path switching member 275. Subsequently, the lenticular sheet 12 falls under the sheet's own weight, and thereby, the lenticular sheet 12 is transported through the transport path B 51 to an outlet (not illustrated).

### [Description of Control System of Printing Apparatus]

Next, the control system of the printing apparatus 10 with the above described configuration will be described.

FIG. 18 is a block diagram illustrating a configuration of a main portion of the printing apparatus 10.

The printing apparatus 10 includes the system controller 400, a program storage unit 402, a buffer memory 404, a sensor unit 406, an operation unit 408, a communication interface (communication I/F) 410, a control unit 420, a mechanical unit 430, a head driver 440 and the thermal head 260.

The system controller 400 is a unit which generally controls the respective units according to a 3D print program, and a CPU (central processing unit) or the like is conceivable as the system controller 400. The 3D print program is stored in the program storage unit 402 including a computer readable, nonvolatile storage medium such as a ROM (read-only memory). The system controller 400 reads and executes the program stored in the program storage unit 402 as appropriate.

The buffer memory 404 is a unit which temporarily stores photographic print data received from a personal computer (PC) (not illustrated) through the communication I/F 410.

The PC connected to the communication I/F 410 obtains color two view point images (left and right images) which are images of the same subject taken by a 3D camera or the like, and calculates a shift amount in a feature point where features coincide with each other (a shift amount between pixels (an amount of parallax)), for each pixel, from these left and right images. After the calculated amount of parallax is adjusted for a 3D print, the adjusted amount of parallax is interpolated to generate six-view images. The PC further performs color conversion of the six-view images of R (red), G (green) and B (blue), into Y (Yellow), M (Magenda) and C (Cyan), and generates a Y signal, an M signal and a C signal for one sheet from the six view point images subjected to the color conversion. These Y signal, M signal and C signal are stored as the photographic print data, in the buffer memory 404 from the PC through the communication I/F 410.

It should be noted that the above described image processing function of the PC may be included in the printing apparatus 10.

The sensor unit 406 includes the photosensors 320A to 320C illustrated in FIG. 14 and sensors which detect positions, rotation angles and the like of various members in the mechanical unit 430, and outputs the detection signal for each detection to the system controller 400.

The operation unit 408 includes a power switch, a print start switch, a switch which sets the number of sheets to be printed and the like, and the like. Signals generated by operations in the operation unit 408 are inputted to the system controller 400.

The mechanical unit 430 includes the sheet transport mechanism 431, a head moving mechanism 432, an ink ribbon drive mechanism 433, the cassette retreat mechanism 434, and the pressure plate drive mechanism 436.

The sheet transport mechanism 431 includes the feed roller 190, the transport roller 212, the capstan 214, the clamper 220 and the drive motor 302 illustrated in FIG. 1 and the like, as well as the damper transport unit 230 (FIG. 14) and the like.

Moreover, the control unit 420 includes a sheet transport control unit 421, a head moving control unit 422, an ink ribbon control unit 423, and a cassette control unit 424.

The system controller 400 outputs each control signal to the control unit 420 depending on a photographic printing sequence, and controls to drive the mechanical unit 430 through the control unit 420.

Thereby, the sheet transport control unit 421 performs the transport so that the lenticular sheet 12 is outputted from the sheet feeding cassette 150 and also the lenticular sheet 12 is moved up/down in the photographic printing. Moreover, the sheet transport control unit 421 has the detection device (not illustrated) which detects the position of the feed roller 190 in the rotation direction, and causes the feed roller 190 to rotate depending on a detection result from the detection device, so as to control the position of the feed roller 190 in the rotation direction.

As described in FIG. 15, the head moving mechanism 432 causes an arm portion having the turning shaft on the same axis as the ribbon cage holder rocking shaft 252A, to turn, and thereby moves the thermal head 260 disposed at a leading end of the arm portion, between the photographic printing position where the thermal head 260 is caused to contact with the platen roller 262, and the retreat position. It should be noted that the retreat position includes a small retreat position and a large retreat position. If only the ink ribbon is fed to perform cueing of the ink, the thermal head 260 is moved to the small retreat position where the thermal head 260 is caused to slightly retreat from the platen roller 262. If the ribbon cage 254 is rotated to switch the ink ribbon to another color ink ribbon, the thermal head 260 is moved to the large retreat position where the thermal head 260 does not interfere with the ink ribbons set at the take-up reels 255 and the supply reels 256.

The ink ribbon drive mechanism 433 includes a mechanism which causes the ribbon cage 254 in the ribbon switching gatling mechanism 250 illustrated in FIG. 15 to rotate, and a reel drive mechanism which drives the five pairs of the take-up reels 255 and the supply reels 256 disposed in the ribbon cage 254.

The cassette retreat mechanism 434 includes the solenoid 122 and the like as described in FIGS. 2 to 4, and rocks the sheet storage main body 110 in response to a command from the system controller 400.

The pressure plate drive mechanism 436 moves the pressure plate 112 as described in FIG. 9, and moves the pressure plate 112 in response to the command from the system controller 400, so that certain pressing force is applied to the lenticular sheets 12 within the cassette.

In the thermal head 260, many heating elements are arranged in a direction orthogonal to the transport direction of the lenticular sheet 12. Based on the photographic print data stored in the buffer memory 404, the system controller 400 controls a temperature of each heating element through the head driver 440 so that a concentration is set corresponding to the photographic print data per line, and sublimates the ink on the ink ribbon to transfer the ink to the lenticular sheet 12, and subsequently, feeds the lenticular sheet 12 by one line by the sheet transport mechanism 431, and continuously causes thermal transfer for each line in a similar manner.

### [Description of Operations of Printing Apparatus]

Next, operations of the printing apparatus 10 will be described.

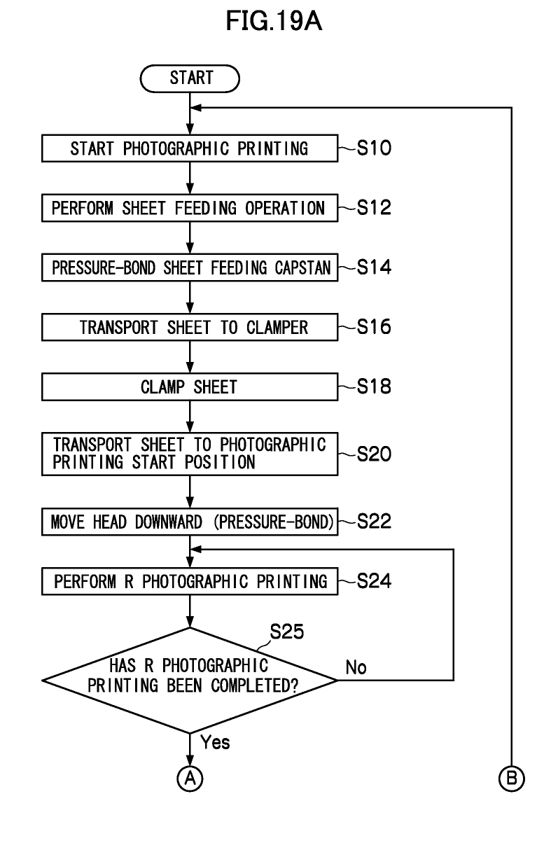

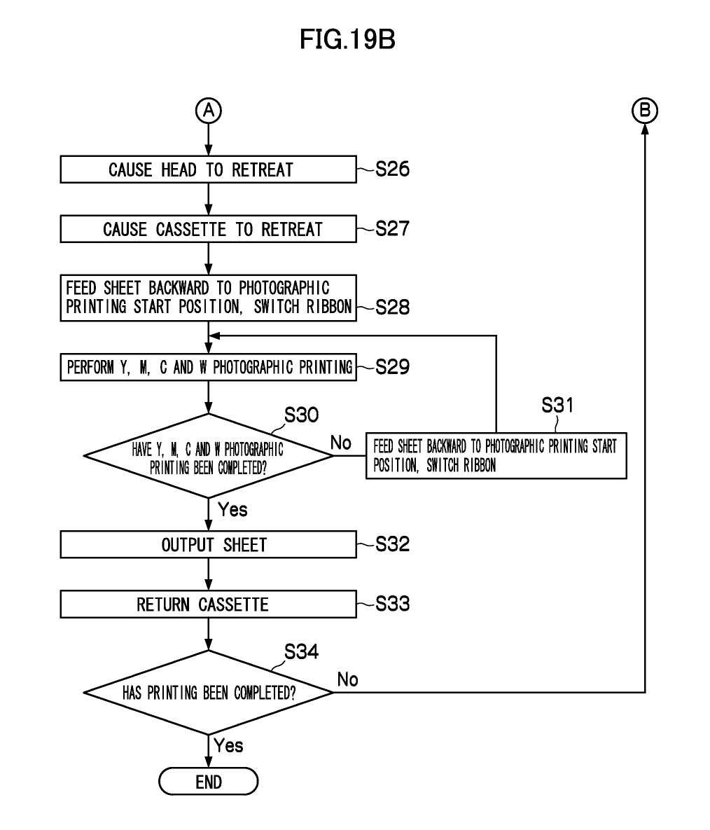

FIGS. 19A and 19B are flowcharts illustrating processing operations in the photographic printing in the printing apparatus 10. Hereinafter, the processing operations will be described according to this flowchart. This photographic printing process is controlled by the system controller 400. A program which causes the system controller 400 to execute this photographic printing process is stored in the program storage unit 402.

### [Step S10]

After the photographic print data for the 3D print is stored in the buffer memory 404, from the PC through the communication I/F 410, when the print start switch of the operation unit 408 is turned on, the photographic printing is started. It should be noted that an instruction to start the photographic printing or the like may be inputted and outputted from the PC connected to the communication I/F 410.

### [Step S12]

When the instruction to start the photographic printing is issued, the system controller 400 first causes the feed roller 190 to perform one rotation, and feeds the lenticular sheet 12 from the sheet storage main body 110 by the certain amount. At this time, the leading end of the lenticular sheet 12 reaches the transport roller 212.

### [Step S14]

The system controller 400 pressure-bonds the capstan 214 to the transport roller 212 so that the lenticular sheet 12 is clamped between the transport roller 212 and the capstan 214. It should be noted that the capstan 214 may be previously pressure-bonded to the transport roller 212, and the lenticular sheet 12 may be inserted between the transport roller 212 and the capstan 214 when the lenticular sheet 12 is fed in step S12.

### [Step S16]

Subsequently, the system controller 400 drives the transport roller 212 for a certain period of time, and transports the lenticular sheet 12 to the damper 220. At this time, the clamper 220 is waiting at the predetermined lowest position, and when the leading end of the lenticular sheet 12 contacts with the damper 220, the transport roller 212 idles. Moreover, rough positioning of the lenticular sheet 12 is performed by causing the lenticular sheet 12 to contact with the damper 220.

### [Step S18]

The system controller 400 drives the cam and the like to close the pair of clamp members by the urging force of the spring, and causes the damper 220 to clamp the lenticular sheet 12. Subsequently, the azimuth adjustment is performed as described in FIG. 14.

### [Step S20]

The system controller 400 drives the clamper transport unit 230 to transport the lenticular sheet 12 clamped by the damper 220, to the photographic printing start position. The photographic printing start position can be, for example, a position where the signals outputted by the photosensors 320A to 320C illustrated FIG. 14 reach a predetermined value (for example, a peak value) after the lenticular sheet 12 is transported. Thereby, relative positions of a lens position of the lenticular sheet 12 and the photographic printing position of the six-view images are adjusted.

### [Step S22]

The system controller 400 controls the head moving mechanism 432 through the head moving control unit 422 to bring the thermal head 260 in pressure contact with the platen roller 262 while the R ink ribbon and the lenticular sheet 12 are sandwiched between the thermal head 260 and the platen roller 262.

### [Step S24]

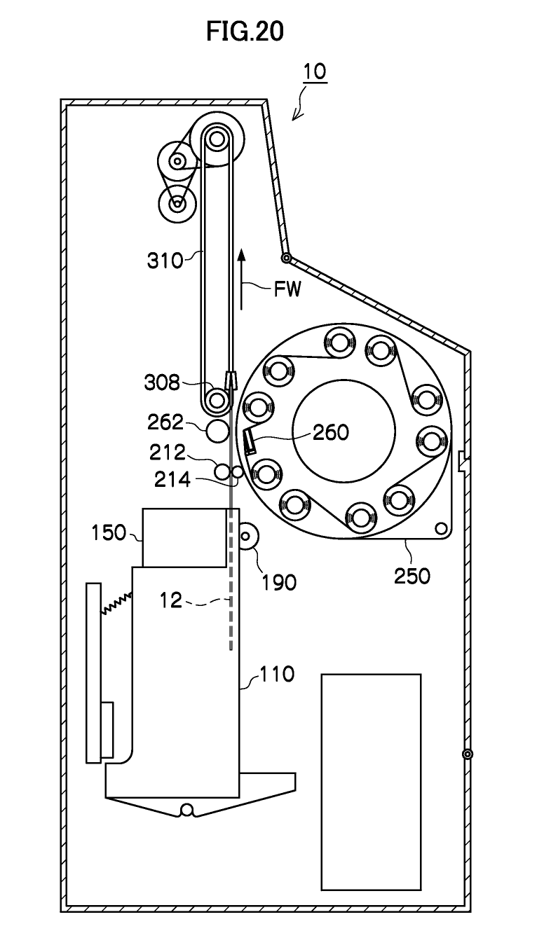

As illustrated in FIG. 20, the system controller 400 causes the drive motor 302 to rotate through the sheet transport control unit 421 so as to drive the damper 220, and moves the lenticular sheet 12 forward in a photographic printing direction FW. In synchronization with the moving of the lenticular sheet 12, while the ink ribbon drive mechanism 433 causes the take-up reel 255 to take up the ink ribbon at the speed which is slightly faster than the moving speed of the lenticular sheet 12, the thermal head 260 is energized and caused to generate heat, and the receiving layer is transferred from the R ink ribbon to the lenticular sheet 12.

### [Step S25]

The system controller 400 determines whether or not formation of the receiving layer with the R ink ribbon has been completed. For example, the system controller 400 makes this determination depending on whether or not the lenticular sheet 12 has been fed by a predetermined amount from the photographic printing start position. If Yes, the process proceeds to S26, and if No, the process returns to S24.

### [Step S26]

After the transfer of the receiving layer is completed, the system controller 400 controls the head moving mechanism 432 through the head moving control unit 422 to move the thermal head 260 to the position where the thermal head 260 does not interfere with the ink ribbon.

### [Step S27]

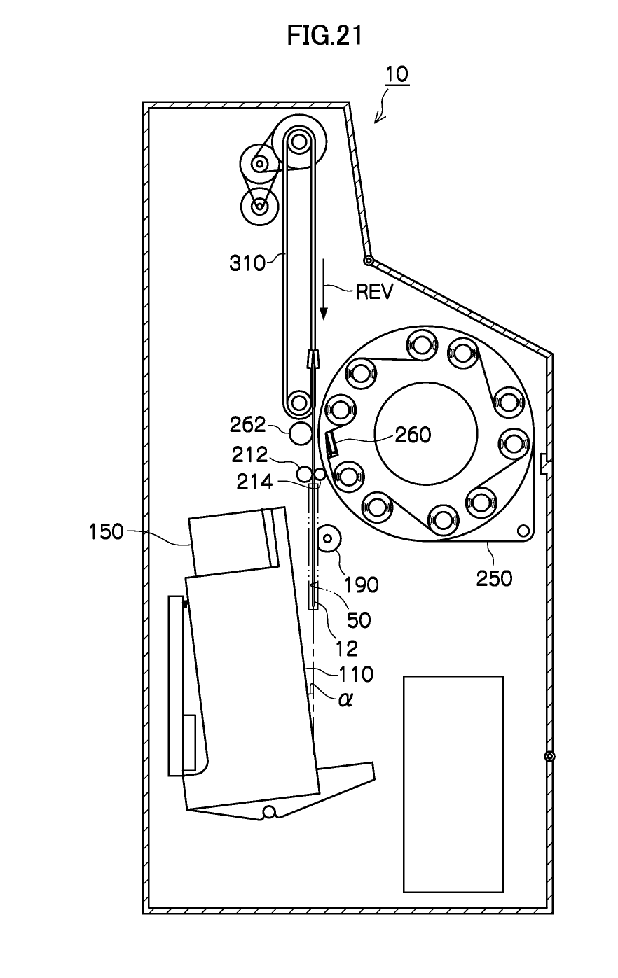

As illustrated in FIG. 21, the system controller 400 controls the cassette retreat mechanism 434 through the cassette control unit 424 to move the sheet storage main body 110 from an initial position to a retreat position where the sheet storage main body 110 is caused to retreat from the transport path 50, and causes the sheet storage main body 110 to be retained at the retreat position.

In other words, when the energization to the solenoid 122 is turned off by the system controller 400, the urging force from the link mechanism 124 is eliminated from the sheet storage main body 110, and the sheet storage main body 110 is urged by the force in the direction of counterclockwise rotation around the rotation shaft 120, by the urging spring 125. The sheet storage main body 110 is turned counterclockwise around the rotation shaft 120 by this urging force of the urging spring 125, and when the sheet storage main body 110 contacts with a stopper (not illustrated), the sheet storage main body 110 is retained at a position where the sheet storage main body 110 is turned by a predetermined angle α. Thereby, the sheet storage main body 110 is caused to retreat from the transport path 50. It should be noted that the sheet storage main body 110 may be retained at the retreat position until the photographic printing of all the colors is completed, or the sheet storage main body 110 may be caused to retreat from the transport path 50 each time the lenticular sheet 12 returns to a cue position in the photographic printing of each color ink ribbon, and may be retained at the initial position except when the lenticular sheet 12 is returned to the cue position.

### [Step S28]

As illustrated in FIG. 21, the system controller 400 controls the sheet transport mechanism 431 through the sheet transport control unit 421 to start to move the lenticular sheet 12 in a reverse direction REV which is opposed to the photographic printing direction FW, that is, from the thermal head 260 toward the sheet storage main body 110, and continues to move the lenticular sheet 12 until the lenticular sheet 12 reaches the printing start position (cue position). Since the sheet storage main body 110 is tilted by the predetermined angle in step S27, the lenticular sheet 12 does not interfere with the sheet feeding cassette 150.

Moreover, the system controller 400 controls the ink ribbon drive mechanism 433 through the ink ribbon control unit 423 to cause the ribbon switching gatling mechanism 250 to rotate to a position of the ink ribbon of color which is set first. Here, the first color is Y, which, however, may be another color. Moreover, the ink ribbon of the color other than Y may be employed.

### [Step S29]

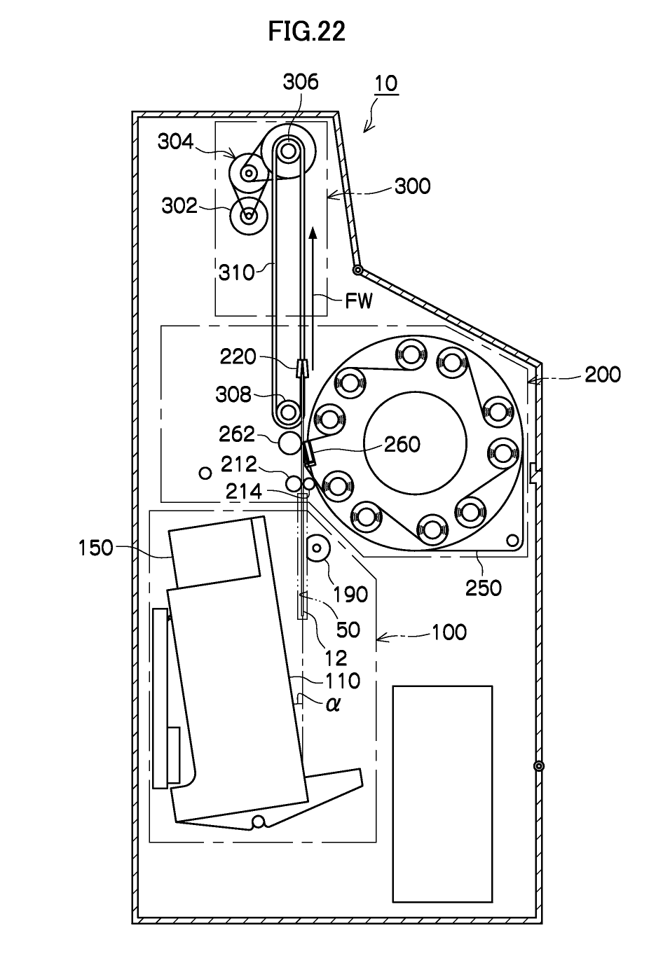

As illustrated in FIG. 22, the system controller 400 brings the thermal head 260 in pressure contact with the platen roller 262 while the switched ink ribbon and the lenticular sheet 12 are sandwiched between the thermal head 260 and the platen roller 262, by the head moving mechanism 432. Subsequently, the system controller 400 causes the drive motor 302 to rotate so as to drive the clamper 220, and moves the lenticular sheet 12 forward in the photographic printing direction FW. In synchronization with the moving of the lenticular sheet 12, while the ink ribbon drive mechanism 433 causes the take-up reel 255 to take up the ink ribbon at the speed which is slightly faster than the moving speed of the lenticular sheet 12, the thermal head 260 is energized and caused to generate heat, a heated color material is transferred from the color ink ribbon to the photographic print surface of the lenticular sheet 12, and the image is formed.

### [Step S30]

The system controller 400 determines whether or not the transfer of all the colors with the color ink ribbons which have been set is completed. This determination can be made similarly to the above described step S25. If Yes, the process proceeds to S32, and if No, the process proceeds to S31.

### [Step S31]

The system controller 400 controls the sheet transport mechanism 431 through the sheet transport control unit 421 to move the lenticular sheet 12 in the reverse direction REV until the lenticular sheet 12 reaches the printing start position (cue position).

Moreover, the system controller 400 controls the ink ribbon drive mechanism 433 through the ink ribbon control unit 423 to cause the ribbon switching gatling mechanism 250 to rotate to the position of the ink ribbon of the color which is set next. Here, while the ribbon switching gatling mechanism 250 is rotated in order of Y, M, C and W, the rotation may be performed in another order. Moreover, ink ribbons of colors other than Y, M, C and W may be employed. After cueing of the sheet and the switching of the ink ribbon, the process returns to S29, and the color is transferred to the photographic print surface of the lenticular sheet 12 with the ink ribbon set next. Subsequently, similarly, the photographic printing of the ink ribbon of the set color, the determination of the completion of the photographic printing with the ink ribbon, as well as the switching of the ink ribbon and the cueing of the lenticular sheet 12 depending on the determination of the completion of the photographic printing are performed for the ink ribbons of all the colors.

### [Step S32]

After the photographic printing of all the colors, the system controller 400 cuts certain areas at front and back end portions of the lenticular sheet 12 by a cutter (not illustrated) and outputs the lenticular sheet 12 by an output mechanism (not illustrated), and thus the photographic printing operation is completed. Any output mechanism may be employed.

### [Step S34]

The system controller 400 determines whether or not the photographic printing has been completed for all the sheets. If Yes, this process is completed. If No, the system controller 400 controls the cassette retreat mechanism 434 through the cassette control unit 424 to retain the sheet feeding cassette 150 stored in the sheet storage main body 110, at the vertical position (step S33).

In other words, when the energization to the solenoid 122 is turned on by the system controller 400, the sheet storage main body 110 is urged by the force in the direction of the clockwise rotation around the rotation shaft 120, by the link mechanism 124. The sheet storage main body 110 is turned clockwise around the rotation shaft 120 by the predetermined angle α (for example, 30°), against the urging force of the urging spring 125, and the sheet storage main body 110 stops at the vertical position (initial position) on the transport path 50. Thereby, similarly to FIG. 1, the sheet storage main body 110 returns to the vertical position. Thereby, the feeding of the next lenticular sheet 12 from the sheet storage main body 110 toward the transport path 50 is enabled. Then, the process returns to S10, and the feeding of the next lenticular sheet 12 is started.

In this way, the lenticular sheet 12 can be linearly transported in the first photographic printing operation (FIG. 20), the return operation (FIG. 21), and the next photographic printing operation (FIG. 22) for the lenticular sheet 12, and also, shortening of the transport path for the lenticular sheet 12 (downsizing of the apparatus) is attempted.

It should be noted that if the determination is Yes in step S34 and the photographic printing to the last lenticular sheet 12 with the last ink ribbon is completed, the energization to the solenoid 122 is turned on. Thereby, the sheet storage main body 110 returns to the vertical position (step S33), and is prepared for the next photographic printing process.

As described above, in this printing process, when the lenticular sheet 12 is transported in the reverse direction REV, the sheet storage main body 110 is moved from the initial position to the retreat position so as to retreat from the transport path 50. Thereby, when the lenticular sheet 12 moves in the reverse direction REV, the lenticular sheet 12 does not interfere with the sheet storage main body 110, and thus the photographic printing is not obstructed. Moreover, the transport path for the lenticular sheet 12 can be shortened and the printing apparatus 10 can be downsized more than a case where the sheet storage main body 110 is arranged at a position far away from the platen roller 262 and the transport roller 212 so that the sheet storage main body 110 does not previously interfere with the cue position of the lenticular sheet 12.

Moreover, according to the present embodiment, the lenticular sheet is pressure-bonded to the feed roller with the predetermined pressure by the pressure plate. Therefore, the lenticular sheet can be outputted from the sheet storage main body by the rotation of the feed roller, and can be fed to the transport path.

Moreover, in the present embodiment, the pressure plate is formed to be generally L-shaped, and the pressure plate is slid in the front direction or the rear direction in the state where the lenticular sheets are placed on the bottom portion. Therefore, even if the lenticular sheets are stacked and become heavy (for example, 2 to 4 kg), the lenticular sheets can be pressure-bonded to the feed roller.

Moreover, according to the present embodiment, since the feed roller is formed to be generally cross-sectionally D-shaped, the feed roller and the lenticular sheet do not interfere with each other, and the sheet feeding cassette, that is, the lenticular sheets can be loaded in the sheet storage main body. Moreover, since the feed roller is generally cross-sectionally D-shaped, the lenticular sheet can be fed from the sheet feeding cassette by the certain amount when the feed roller is caused to perform one rotation. Therefore, when the leading end of the lenticular sheet is caused to reach the transport roller, subsequently, the lenticular sheet is not transported by the feed roller, and thus, the lenticular sheet can be prevented from being transported by both the feed roller and the transport roller.

Moreover, according to the present embodiment, the rocking of the rear portion of the pressure plate is detected, and when the rocking is detected, the pressure plate is moved parallel in the front direction. Therefore, the position of the pressure plate can be controlled so that the pressure plate constantly presses the lenticular sheets with the certain pressure.

Moreover, according to the present embodiment, since the pushing portion and the feed roller are disposed to face each other, the lenticular sheet can be appropriately pressure-bonded to the feed roller.

It should be noted that, in the present embodiment, the rear portion 112b of the pressure plate 112 is rockably disposed, and the pushing plate 112d disposed at the rear portion 112b presses the lenticular sheets 12. However, the rear portion 112b and the bottom portion 112a may be fixed so that the entire rear portion 112b presses the lenticular sheets 12. In this case, even if the lenticular sheet 12 curls or skews, the lenticular sheet 12 can be flattened by the pressure plate 112, and the lenticular sheet 12 can be outputted from the sheet feeding cassette 150.

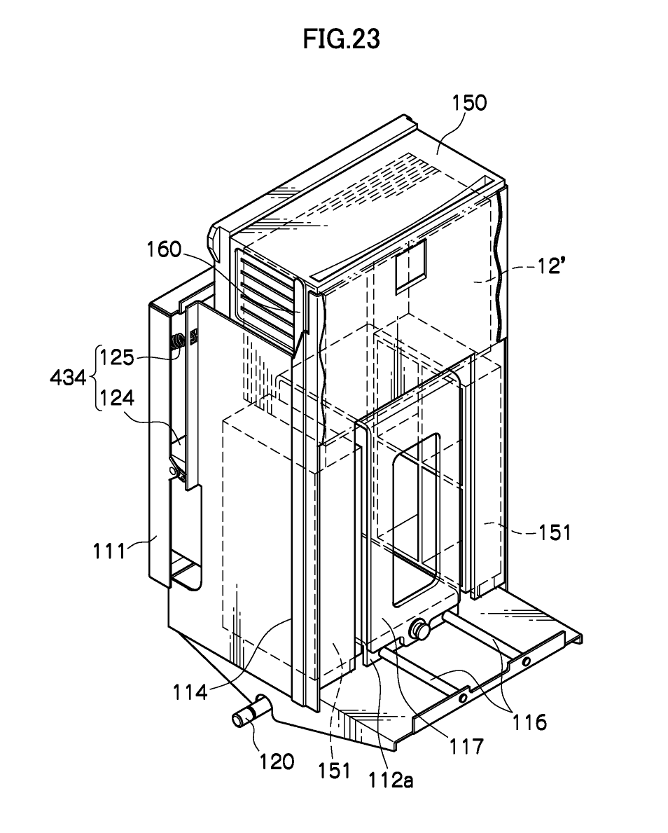

Moreover, in the present embodiment, the lenticular sheets 12 are placed on the bottom portion 112a. However, lenticular sheets of different sizes can be accepted by using additional parts as illustrated in FIG. 23. FIG. 23 is a perspective view of the main portion in a case where lenticular sheets 12′ smaller than the lenticular sheets 12 are used.

A raising member 117 which adjusts a height of the bottom portion 112a is disposed on the top of the bottom portion 112a, in accordance with a size of the lenticular sheet 12′.

Adjustment members 151 which adjust a height of the sheet feeding cassette 150 are inserted in both ends within the sheet feeding cassette 150, in accordance with the size of the lenticular sheet 12′. When the adjustment members 151 are inserted, the lenticular sheets 12′ are inserted on the adjustment members 151 within the sheet feeding cassette 150.

When the sheet feeding cassette 150 in which the lenticular sheets 12′ are inserted is inserted into the sheet storage main body 110 (not illustrated in FIG. 23), a height of the lenticular sheets 12′ is raised by the raising member 117, and also, the pressure plate 112 (not illustrated in FIG. 23) is moved in the front direction by the pressure plate drive mechanism 436 (not illustrated in FIG. 23), and the pushing plate 112d (not illustrated in FIG. 23) presses the lenticular sheets 12′ within the sheet feeding cassette 150.

Thereby, the lenticular sheet 12′ can be outputted from the sheet feeding cassette 150. The same apparatus can be used to accept lenticular sheets of various sizes, by preparing raising members and adjustment members of various sizes corresponding to the lenticular sheets of various sizes.

Moreover, in the present embodiment, the sheet storage main body 110 is retained at the retreat position until the printing operation is completed. However, the sheet storage main body 110 may be caused to retreat from the transport path 50 each time the lenticular sheet 12 returns to the cue position in the photographic printing of each color ink ribbon, and the sheet storage main body 110 may be retained at the initial position except when the lenticular sheet 12 is returned to the cue position.

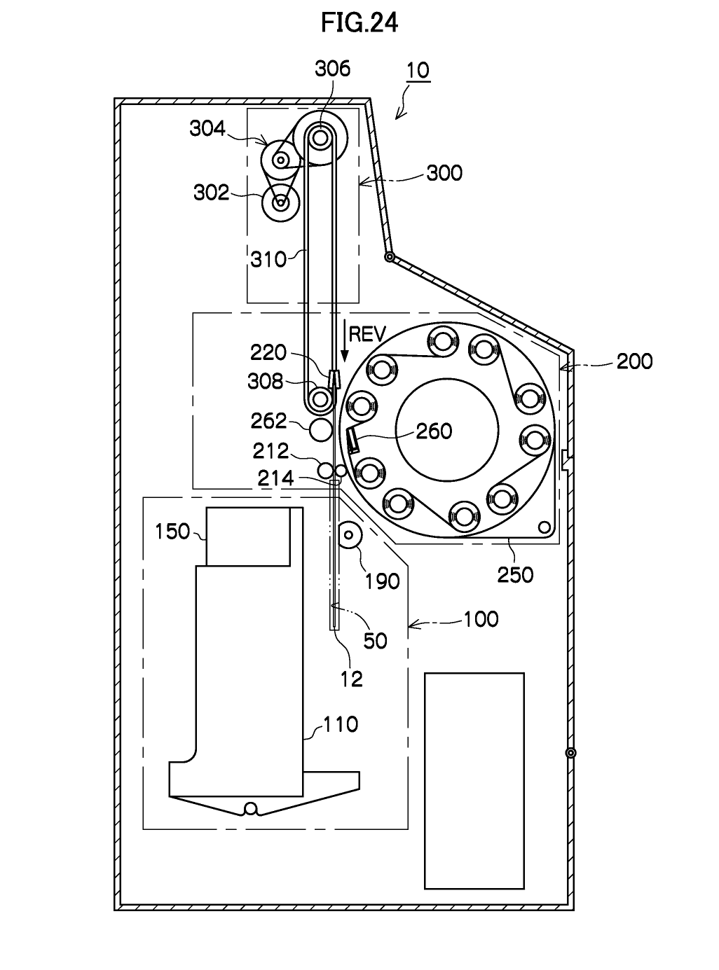

Moreover, instead of causing the cassette to retreat from the transport path 50 by the turning, the sheet feeding cassette 150 may be caused to retreat from the transport path 50 by a moving mechanism which moves the sheet feeding cassette 150 from the transport path 50, in a vertical direction, in a horizontal direction, or in the both directions. In FIG. 24, the sheet storage main body 110 is moved from the transport path 50 in the horizontal direction, and thereby caused to retreat from the transport path 50.

Moreover, in the present embodiment, the receiving layer is transferred from the R ink ribbon at the thermal head 260. However, instead of transferring the receiving layer from the R ink ribbon at the thermal head 260, the receiving layer may be previously formed on the lenticular sheet 12. In this case, steps S24 to 27 of the flowchart illustrated in FIGS. 19A and 19B are omitted. Instead, after the color transfer with the first color ink ribbon, for example, the Y ink ribbon, is completed, the cassette is caused to retreat similarly to S27, and the transfer with the next color ink ribbon is performed.

It should be noted that the scope of application of the presently disclosed subject matter is not limited to the sublimation printer using the ink ribbons, and the photographic print medium is not limited to the lenticular sheet having the lens surface and the photographic print surface, either. For example, if the azimuth adjustment is enabled without detecting the lens position by the photosensors 320A, 320B and 320C, the photographic printing may be performed on a medium which has only the photographic print surface and to which the lens surface is not applied. The presently disclosed subject matter is also applicable to various methods in which an image is formed on a print medium while the print medium is reciprocated along the transport path (for example, a thermo-autochrome (TA) printer, an ink-jet printer, a thermofusible transfer method, a silver halide photography (thermal development transfer) method, and ZeroInk (registered trademark)).

### Second Embodiment

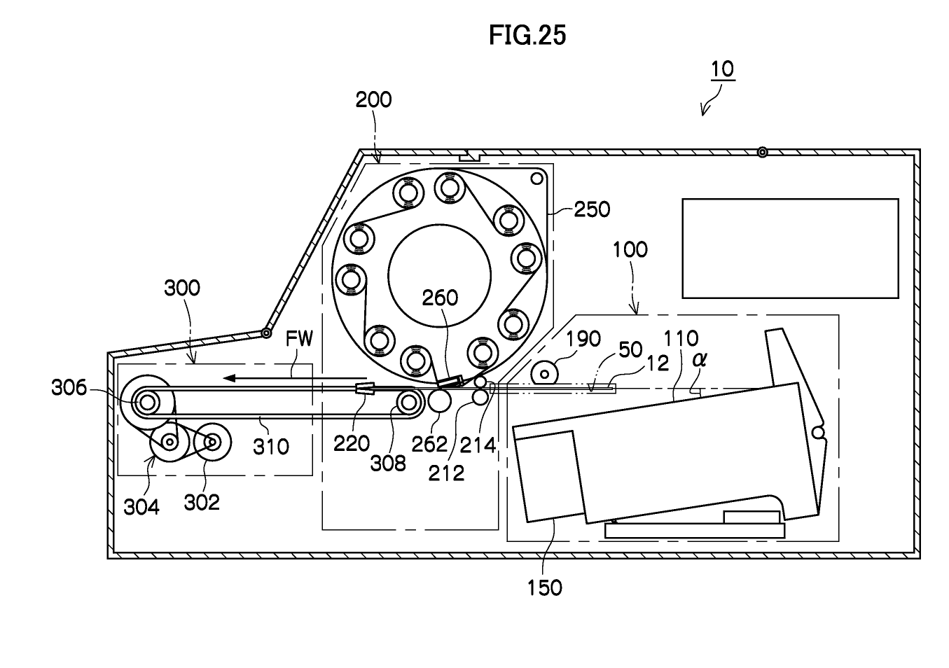

FIG. 25 is an internal perspective view schematically representing the printing apparatus 10 according to a second embodiment of the presently disclosed subject matter.

As illustrated in FIG. 25, this printing apparatus 10 is a horizontally placed 3D printer which transports the lenticular sheet 12 in a reciprocating manner in the horizontal direction along the transport path 50, and performs the photographic printing. The same reference numerals and characters are assigned to the same mechanisms as those in FIG. 1 and the like.

The printing apparatus according to the second embodiment has a configuration similar to the printing apparatus 10 according to the first embodiment, except that the lenticular sheet 12 performs reciprocating motion to move forward and backward in the horizontal direction, instead of the vertical direction. Of course, in the first embodiment, there is no problem of the bending of the lenticular sheet 12 due to gravity action. On the other hand, this bending of the lenticular sheet 12 due to gravity action becomes a problem in the second embodiment. It is also conceivable that the lenticular sheet 12 may not be linearly guided to the transport path 50, and the photographic print surface and the lens surface of the lenticular sheet 12 may be scratched, due to the bending of the lenticular sheet 12 in the vertical direction. In order to prevent such a scratch and eliminate a tendency to bend, soft transport members, such as a plurality of pairs of rubber decal rollers which clamp continuous labels, are preferably provided vertically from upper and lower directions of the lenticular sheet 12, on an upstream side of the transport path 50 (between the sheet storage unit 100 and the thermal head 260).

What is claimed is:

1. A printing apparatus, comprising:
a photographic printing unit adapted to perform photographic printing on a photographic print surface of a medium including a flexible sheet-like member while maintaining a state where the photographic print surface of the medium faces a photographic printing head;
a medium moving unit adapted to generally linearly move the medium in the state where the photographic print surface of the medium faces the photographic printing head of the photographic printing unit; and
a photographic printing control unit adapted to control the medium moving unit and the photographic printing unit to perform the photographic printing on the photographic print surface of the medium by the photographic printing head while moving the medium by the medium moving unit.

2. The printing apparatus according to claim 1, wherein
the medium moving unit is adapted to generally vertically move the medium in the state where the photographic print surface of the medium faces the photographic printing head.

3. The printing apparatus according to claim 1, wherein
the medium moving unit is adapted to generally horizontally move the medium in the state where the photographic print surface of the medium faces the photographic printing head.

4. The printing apparatus according to claim 1, wherein
the medium moving unit comprises:
a damper adapted to clamp the medium;
a first guide member adapted to generally linearly slide the damper; and
a damper drive unit adapted to drive the damper clamping the medium, along the guide member.

5. The printing apparatus according to claim 4, further comprising:
a medium storage unit adapted to store the medium; and
a second guide member adapted to linearly guide the medium from the medium storage unit to the damper.
